(19) United States
(12) Patent Application Publication
(10) Pub. No.: US 2007/0112859 A1
(43) Pub. Date: May 17, 2007

(54) ABSTRACTION OF UPnP CONTAINER SYSTEM FOR NON-SEARCHABLE DEVICES

(75) Inventor: ANIRUDH JAY JOSHI, San Jose, CA (US)

Correspondence Address: DVA/PIONEER RESEARCH CENTER USA, INC., 2265 E. 220TH STREET, LONG BEACH, CA, 90810, US

(73) Assignee: PIONNER RESEARCH CENTER USA, INC., San Jose, CA (US)

(21) Appl. No.: 11/559,874

(22) Filed: Nov. 14, 2006

Related U.S. Application Data
(60) Provisional application No. 60/737,060, filed on Nov. 16, 2005.

(51) Int. Cl. G06F 17/00

(52) U.S. Cl. 707/104.1

(57) ABSTRACT

The method is provided to enable the container system for UPnP device that do not support search capabilities. The method includes the step of detecting whether a first server exists. In the next step, the method determines the first server search capability. If the server has search capability, the method then determines whether the first server has a known container organization. If not, the method harvests metadata from the first server and stores the metadata in a database of a device having a second server.

### CROSS REFERENCE TO RELATED APPLICATION

This application claims priority of U.S. application No. 60/737,060, filed Nov. 16, 2005.

### FIELD OF THE INVENTION

This invention relates to a Universal Play-n-Plug container system. More particularly, the invention relates to the enabling of a container system for non-searchable Universal Plug-n-Play (UPnP) devices.

### DESCRIPTION OF RELATED ART

Universal Plug and Play (UPnP) technology helps make home networking simple and affordable for users. The UPnP is intended to automate the installation and configuration of a small network such as a home network. While the UPnP media servers are not required to support containers and searching based on metadata, some servers such as Windows Media Connect support searching and the container system. UPnP technology not only offers network connectivity of PCs, intelligent appliances, and wired and wireless devices, it also may be used to enable control and data transfer among network devices in the home. Furthermore, UPnP technology can support essentially any operating system and almost any type of physical networking media.

To browse content on UPnP servers that do not support searching capability, the rendering client device (e.g., BluRay product, Plasma Media Receiver, AV Receiver) only displays a flat view of the content. This invention is a method, apparatus, and system of abstracting devices that can and represent the content as a unified media container user interface.

### BRIEF DESCRIPTION OF THE DRAWINGS

The invention may best be understood by referring to the following description and accompanying drawings that are used to illustrate embodiments of the invention. In the drawings:

FIG. 1 is a block diagram illustrating a computer system in which one embodiment of the invention can be practiced.

FIG. 2A is a block diagram illustrating a server/user interface system, which uses conventional practice.

FIG. 2B is a block diagram illustrating a servers/user interface system, including a user device, in which one embodiment of the present invention can be practiced.

FIG. 2C is a diagram illustrating a graphical user interface in which one embodiment of the present invention can be practiced.

FIG. 2D is a block diagram illustrating an application's user interface layout in which one embodiment of the present invention can be practiced.

FIG. 3 is a block diagram illustrating a container organization system in which one embodiment of the invention can be practiced.

FIG. 4 is a flowchart illustrating a process for determining search capabilities of UPnP server according to one embodiment of the invention.

FIG. 5 is a flowchart illustrating a process to transform metadata according to one embodiment of the invention.

FIG. 6 is a flowchart illustrating a process to determine whether searching capability is supported in the container system according to one embodiment of the invention.

FIG. 7 is a flowchart illustrating a process to determine whether searching capability is supported in a known container organization according to one embodiment of the invention.

FIG. 8 is a diagram illustrating a process of enumerating different categories on a server in which one embodiment of the invention can be practiced.

### GENERAL DESCRIPTION OF THE INVENTION

One embodiment of the invention is a technique to enable a container system for Universal Plug-n-Play (UPnP) devices that do not support search capabilities for such systems. The invention is a method, apparatus, and system of abstracting devices (that do not support media metadata a container system), which can and represent the content as a unified media container user interface.

In the following description, numerous specific details are set forth. However, it is understood that embodiments of the invention may be practiced without these specific details. In other instances, well-known circuits, structures, and techniques have not been shown in order not to obscure the understanding of this description.

Elements of one embodiment of the invention may be implemented by hardware, software, firmware, microcode, or any combination thereof. When implemented in software, firmware, or microcode, the elements of the embodiment of the present invention are the program code or code segments to perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the machine accessible medium include an electronic circuit, a semiconductor memory device, a read-only memory (ROM), a flash memory, an erasable ROM (EROM), a floppy diskette, a compact disk (CD-ROM), an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The machine accessible medium may be embodied in an article of manufacture. The machine accessible medium may include data that, when accessed by a machine, cause the machine to perform the operation described in the following. The term “data” here refers to any type of information that is encoded for machine-readable purposes. Therefore, it may include program, code, data, file, etc. The program, code, etc. may be embedded in a processor of a plasma media receiver, an AV receiver, or a BluRay player product.

As described above, all or part of an embodiment of the invention may be implemented by software. The software may have several modules coupled to one another. A software module is coupled to another module to receive variables, parameters, arguments, pointers, etc. and/or to generate or pass results, updated variables, pointers, etc. A software module may also be a software driver or interface to interact with the operating system running on the platform. A software module may also be a hardware driver to configure, set up, initialize, send and receive data to and from a hardware device.

It is noted that an embodiment of the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

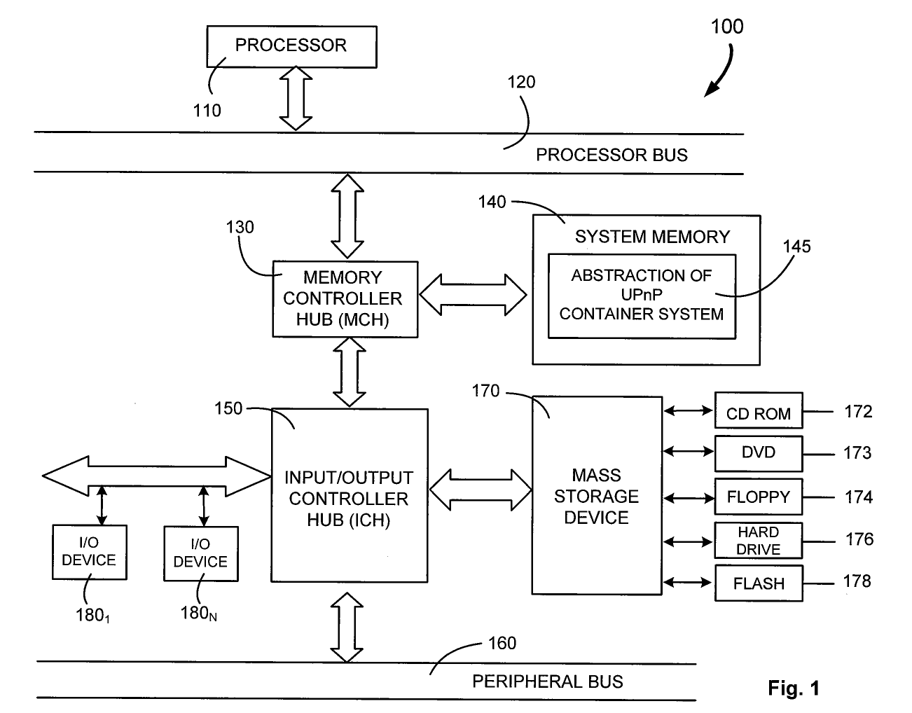

FIG. 1 is a diagram illustrating a processor system 100 in which one embodiment of the invention can be practiced. The processor system 100 includes a processor 110, a processor bus 120, a memory control hub (MCH) 130, a system memory 140, an input/output control hub (ICH) 150, a peripheral bus 160, a mass storage device 170, and input/output devices 180₁ to 180_{N}. Note that the processor system 100 may include more or less elements than these elements.

The processor 110 represents a central processing unit of any type of architecture, such as embedded processors, mobile processors, micro-controllers, digital signal processors, super scalar computers, vector processors, single instruction multiple data (SIMD) computers, complex instruction set computers (CISC), reduced instruction set computers (RISC), very long instruction word (VLIW), or hybrid architecture. For example, the central processing unit may be an embedded processor in a BluRay players product, a plasma media receiver, or an AV receiver.

The processor bus 120 provides interface signals to allow the processor 110 to communicate with other processors or devices, e.g., the MCH 130. The processor bus 120 may support a uni-processor or multiprocessor configuration. The processor bus 120 may be parallel, sequential, pipelined, asynchronous, synchronous, or any combination thereof.

The MCH 130 provides control and configuration of memory and input/output devices, the system memory 140, and the ICH 150. The MCH 130 may be integrated into a chipset that integrates multiple functionalities such as the isolated execution mode, host-to-peripheral bus interface, and memory control. The MCH 130 interfaces to the peripheral bus 160. For clarity, not all the peripheral buses are shown. It is contemplated that the system 140 may also include peripheral buses such as Peripheral Component Interconnect (PCI), accelerated graphics port (AGP), Industry Standard Architecture (ISA) bus, and Universal Serial Bus (USB), etc.

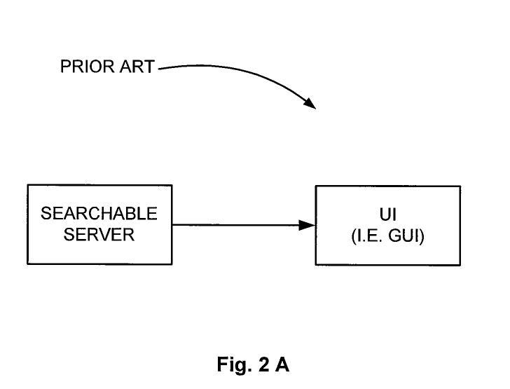

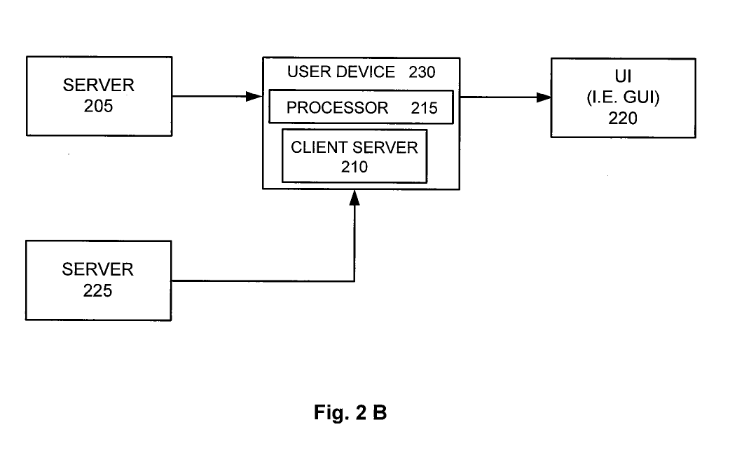

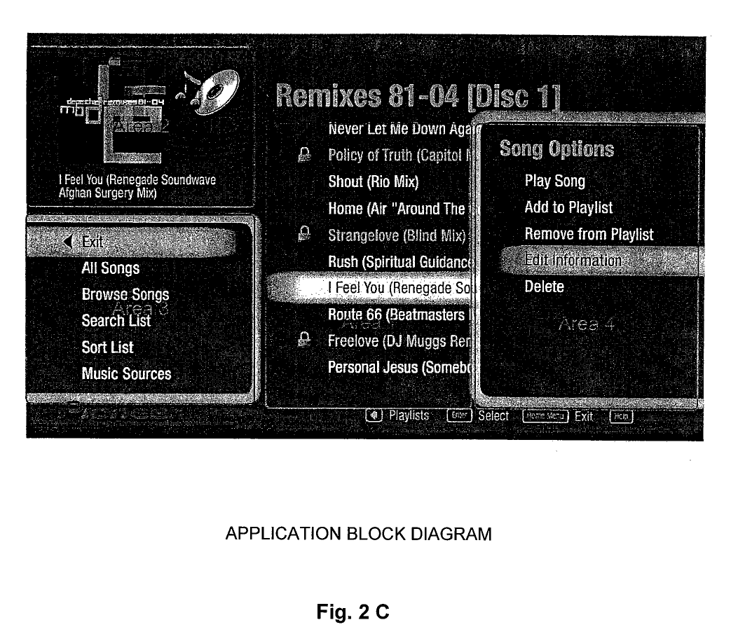

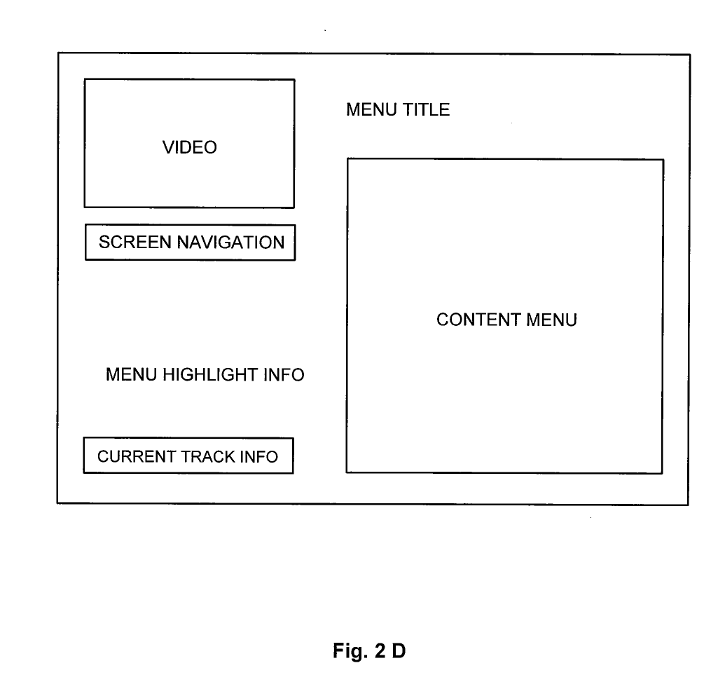

The system memory 140 stores system code (i.e., code to enable a container system for UPnP devices) where system does not support the searching capabilities for the UPnP devices. The system memory 140 is typically implemented with dynamic random access memory (DRAM) or static random access memory (SRAM). The system memory 140 may include program code or code segments implementing one embodiment of the invention. The system memory includes server 145 (i.e., abstraction of UPnP container system, i.e., user device 230). Any one of the elements of the user device 145 may be implemented by hardware, software, firmware, microcode, or any combination thereof. The system memory 140 may also include other programs or data, which are not shown, such as an operating system. The server 145 contains program code that, when executed by the processor 110 (or processor 215 as shown in FIG. 2B), causes the processor 110 to perform operations as described below.

The ICH 150 has a number of functionalities that are designed to support I/O functions. The ICH 150 may also be integrated into a chipset together or separate from the MCH 130 to perform I/O functions. The ICH 150 may include a number of interface and I/O functions such as PCI bus interface to interface to the peripheral bus 160, processor interface, interrupt controller, direct memory access (DMA) controller, power management logic, timer, system management bus (SMBus), universal serial bus (USB) interface, mass storage interface, low pin count (LPC) interface, etc.

The mass storage device 170 stores archive information such as code, programs, files, data, applications, and operating systems. The mass storage device 170 may include compact disk (CD) ROM 172, a digital video/versatile disk (DVD) 173, floppy drive 174, hard drive 176, flash memory 178, and any other magnetic or optic storage devices. The mass storage device 170 provides a mechanism to read machine-accessible media. The machine-accessible media may contain computer readable program code to perform tasks as described in the following.

The I/O devices 180₁ to 180_{N} may include any I/O devices to perform I/O functions. Examples of I/O devices 180₁ to 180_{N} include controllers for input devices (e.g., keyboard, mouse, trackball, pointing device), media cards (e.g., audio, video, and graphics), network cards, and any other peripheral controllers. Elements of one embodiment of the invention may be implemented by hardware, firmware, software or any combination thereof. The term hardware generally refers to an element having a physical structure such as electronic, electromagnetic, optical, electro-optical, mechanical, electro-mechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc. that is implemented or embodied in a hardware structure (e.g., flash memory, ROM, EROM). Examples of firmware may include microcode, writable control store, and micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read-only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, causes the machine to perform the operations described in the following. The machine accessible medium may also include program code embedded therein. The program code may include machine-readable code to perform the operations described below. The term “data” here refers to any type of information that is encoded for machine-readable purposes. Therefore, it may include program, code, data, file, etc.

### DETAILED DESCRIPTION OF THE INVENTION

FIG. 2A is a block diagram illustrating a prior art searchable server/user interface system. As shown on this figure, the system only supports a searchable server where it is connected to a user interface. In the case where the UPnP device of the server does not have searchable capabilities, the UPnP will forego the control and data transfer among the network devices.

FIG. 2B is a block diagram illustrating a system 200 in which one embodiment of the invention can be practiced. The system 200 includes a server 205, which is a non-searchable server where the UPnP device(s) of the server does not support the searchable capabilities), a server 225, which is a searchable server (where the UPnP device(s) of the server has searchable capabilities, a user/client device 230 (e.g., BluRay player, etc.) which includes a client server 210 (which has the searchable capabilities for the computer code embedded inside the user device 230 to enable container system for UPnP devices in the server 205 (where these devices do not support the container system), and a user interface 220 (e.g., a graphical user interface). In one embodiment the user interface is a graphical user interface, which is a program interface. The graphical user interface may feature components such as pointers, pointing devices, icons, menus, etc. The user device 230 also includes a processor 215. The processor 215 executes program code to perform the operations that carry out the invention.

The user device 230 may be the system 100 as described in FIG. 1. The user device 230 includes computer code that is embedded in the processor 215 to enable the container system for UPnP device in server 205. The user device performs the abstraction of the UPnP container system for non-searchable devices.

In the user device 230, computer code is embedded in its processor. The code processes method of abstracting devices (i.e., UPnPs), that do not support the media metadata container system with devices, that can and represent this content in the client server 210 as a unified media container user interface. In other words, the user device 230 provides the enabling of a container system for Universal Plug-n-Play (UPnP) devices in the case where these devices do not support the systems with searching or categorizing capabilities. The invention is a method, apparatus, and system of abstracting devices that do not support a media metadata container system with devices that can and represent content as a unified media container user interface.

Even though the UPnP media servers are not required to support containers and search based on metadata, some servers do support advance searching and a container system (e.g., server 205 and UI 220). The client server 210 acts as a media server that support advance searching as those servers, which also have the support.

To browse content on servers (i.e., server 205), which do not support searching capabilities; the rendering device (i.e., the client device 230) could only display a flat view of the content. The client/user device 230 may be one of BluRay products such as a BluRay player, a receiver such as a plasma receiver, or an AV receiver, etc. The UPnP device from server 205 can only show the “all” container and cannot categorize their content from server 205. This may present a user interface (UI), i.e., UI 220 problem for device that supports both searchable and non-searchable devices. The client must present two different user interfaces to user. This first type being a complete categorized interface, where the user can navigate different types of containers, and the second being a single “all” container.

Despite the lack of searching capability, these servers can still produce the associated metadata, which make up the searchable servers container system. By downloading the entire “all” container and then storing the metadata, the client can then search within that metadata to reproduce the containers that the server lacks to produce. It is noted that the metadata may include schema, table, index, view and column definitions and that it may be used to describe other data. The metadata may be a description of a database in term of its structures and the relationship between the entities in it. Metadata stored in a database may include header keyword values, file location information, etc.

The client stores the entire metadata in an internal database on the client device 230, which it can query based on the same searchable containers to represent an identical user interface for both types of servers. The application layer software of the client device 230 does not need to know if a server is searchable or not. The abstracted container layer will return the same data. The abstracted layer will either retrieve the data from the server (i.e., server 225) or use its internal database of client server 210 to perform the query.

FIG. 2C is a diagram illustrating a graphical user interface in which one embodiment of the present invention can be practiced. The user interface (UI) 230 may be a graphical user interface (GUI) which, for example, may include music, movie, and/or photo applications for use in Blu-Ray Disc (BD) player in a disc navigation mode. The UI 230 includes screens that appear during an application runtime where the application may consist of one large navigable menu, buttons for screen change navigation and other information text areas. The music application also support browsing and playback from a data source such as optical disc (i.e., BD-ROM, BD-RE, DVD, and DVD-VR). The music application enters into a screen (i.e., all songs screen), which displays a listing of all supported music content probed on the disc. A user may choose to browse the list of content or select global options or song-specific options. The user can enter the artist menu or album menu from a menu (i.e., main, albums, song or genres menu) depending on which direction the user is traversing through the content. The genres menu lists all currently available music genre categories which have content associated with them. If a genre exits, but has no music content, it will not appear in the genres menu. The number of songs associated with each genre is also displayed. The search feature of the application is a real-time search implementation with dynamic result updates. While the user is entering the search criteria, the result field is dynamically populated with results based on the currently entered data in the search field. The search results list display the current result set of the search entry.

FIG. 2D is a block diagram illustrating an application's user interface layout in which one embodiment of the present invention can be practiced. The layout displays a menu title, a video section, a screen navigation section, a content menu section, a menu highlight information section, and a current track information section. Upon entering any new screen in the application, the content menu animates in for the screen. When the user moves from one screen to another using OSD navigation, the path will be remembered. A back button on each screen takes the user to the previous screen in sequence of the screens previously viewed. All content is dynamically generated, based on the user's hierarchical navigation.

The photo application supports browsing and playback from data source such as optical disc (i.e., BD-R, DVD-R). The photo application enters into all photo screens, which displays a listing of all supported photo content probed on the disc. The user may choose to browse the list of content or select global options or photo-specific options. The movie application also supports browsing and playback from the data source such as optical disc (i.e., BD-ROM, BD-RE, DVD, and DVD-VR). Like other applications (i.e., photo application), the movie application supports browsing and playback from data source, i.e. optical disc (BD-ROM, BD-RE, DVD, DVD-VR). The movie application enters into the all movie screens, which displays a listing of all supported movie content provided on the disc. The user may choose to browse the list of content or select global options or movie-specific options. The genres menu lists all currently available movie genre categories which have content associated with them. If a genre exists, but has no movie content, it will not appear in the genres menu. The number of movies associated with each genre is also displayed. Also like other applications, the search feature of the movie application is a real-time implementation with dynamic result updates. While the user is entering the search criteria, the results field is dynamically populated with results based on the currently entered data in the search field. The search results list displays the current result set of the search entry. The movie menu displays a movie content listing based on the user's desired navigation path. The movie options menu presents the user with options to be applied to the selected movie.

It is noted that the above sections described the disc navigation applications with PC data file content. There is also a mode selection feature where when a disc with both DVD/BD titles and PC data mode files is inserted, the disc navigation menu presents an option for the user to select which mode he/she wishes to use. For instance, when a DVD/BD video disc with no PC data files is probed, the application enters with a listing of all DVD/BD titles. The user may select a title to play or select a title to view its chapters. If only one title exists, the list of chapters of that title is displayed. For another instance, the all movie screen displays the DVD/BD disc title (if not available, then it displays “DVD” or “BD”) and the remaining PC data file movies. Selection of the DVD/BD displays a list of titles, then chapters. If only one title is available, then a listing of chapters is displayed.

The applications are applicable to products such as plasma media receiver, AV receiver, and BluRay players. The applications also are applicable to products with no hard disc drive. Thus, there is no local media content storage capability, and the product requires an external source for content.

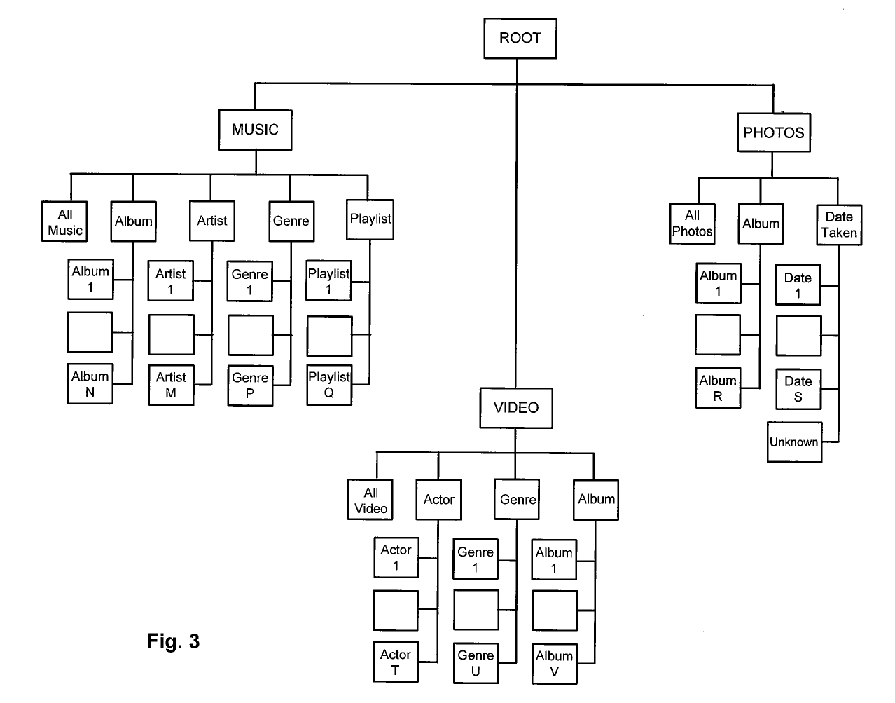

FIG. 3 is a block diagram illustrating a container organization system in which one embodiment of the invention can be practiced.

The block diagram shows one embodiment of the data in a container system for the UPnP devices. At the root, the metadata is divided into several subcategories (e.g., music, video/movie, and photos). It is noted that the metadata may be included in more than these three subcategories and that these are just examples of embodiments that the invention can be practiced. Under the music category, the metadata may be divided into subcategories such as all music, album, artist, genre, playlist, etc. The music, artist, genre, and playlist may be divided into groups such as album 1 to album N, artist 1 to artist M, genre 1 to genre P, playlist 1 to playlist Q where N, M, P, and Q are positive integers. Under the video category, the metadata may be divided into subcategories such as all video, actor, genre, album, etc. The video, actor, genre, album may be divided into groups such as different actors, different genres, different albums, etc. Under the photos category, the metadata may be divided into subcategories such as all photos, album and date taken, etc. Again, the all photos, album and date taken, etc. may be divided into groups such as different albums, different dates, etc.

As mentioned earlier, the UPnP media servers are not required to support containers and searching based on metadata. However, some servers like Windows Media Connect (WMC) support very advance searching and a container system.

Once again, to browse content on servers, which do not support searching, the rendering device (the client device) could only display a flat view of the content. This type of device can only show the “All” container and cannot categorize their content. This presents a UI problem for the device that must support both searchable and non-searchable devices. The client device must present two different user interfaces to user. The first type being a complete categorized interface, where the user can navigate different types of containers, and the second being a single “All” container.

Despite the lack of searching capability, these servers can still produce the associated metadata, which make up the searchable servers container system. By downloading the entire “All” container and then storing the metadata, a client can then search within that metadata to reproduce the containers that the server lacks to produce.

The client stores the entire metadata in an internal database, which it can query, based on the same searchable containers to represent an identical user interface for both types of servers. The application layer software does not need to know if a server is searchable or not, the abstracted container layer will return the same data. The abstracted layer will either retrieve the data from the server or use its internal database to perform the query.

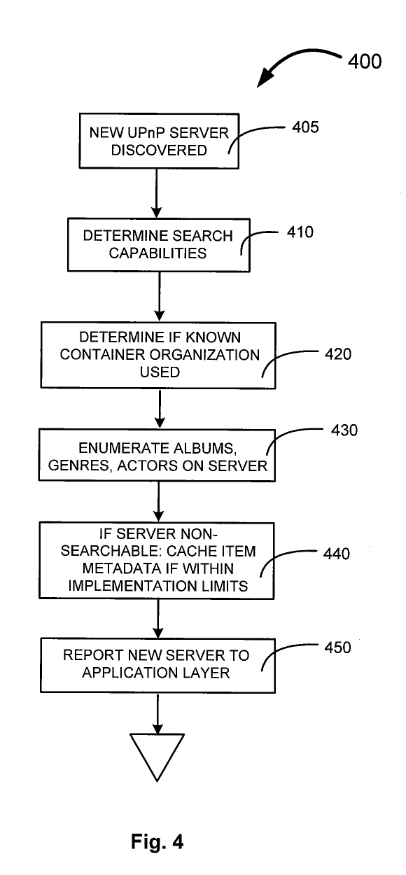

FIG. 4 is a flowchart illustrating a process for determining search capabilities of UPnP server according to one embodiment of the invention. At step 405, the process 400 discovers or detects that a new Universal Plug-n-Play (UPnP) device is present. This UPnP device may or may not have the search capacities or that it may or may not support enabling of a search of the container system. In other words, at this point of discovery, the client (i.e., BDP client) does not know whether the server (i.e., server 205 or server 225) has the searchable capability or not. Even though the UPnP devices of media servers are not required to support containers and searching based on metadata, some servers (e.g., Windows Media Connect (WCM), however, do support searching and/or categorizing the container system. At step 410, the process 400 determines whether the system has such search/categorize capabilities (i.e., whether the server is server 205 or server 225). The process 400 continues at step 420 to determine whether a known container organization is used. This step is to determine if the server uses “known containers”, i.e., “Genre”, “Album”, “Artist”, etc. Some servers may create their own containers, i.e., “Director” or “Producer”. These may be considered non-standard containers, which the system may not support. If it is found that the server has non-standard containers, the server may be categorized as a non-searchable server since the system expects to find “known containers” as these non-standard containers are different from the standard containers known to the system. If this is the case, the system collects as much supported metadata as possible. If the server found contain metadata is non-searchable and it has a known container organization, the system starts to harvest all the metadata into its internal database. For example, when a user starts looking for all songs within the genre “Rock”, it will search the system internal database instead of inquire it from the device since the device is a non-searchable device, it does not have the search capability. The process 400 continues at step 430 to enumerate albums, genres, actor, etc. on the server. If it is determined at step 440 that the server is non-searchable or is not supported by search/categorize capacities, the metadata is cache as cache item in the client server within the client server implementation limits. The process 400 continues at step 450 by reporting to the application layer of the user/client device (i.e., device 230) that a new server is present.

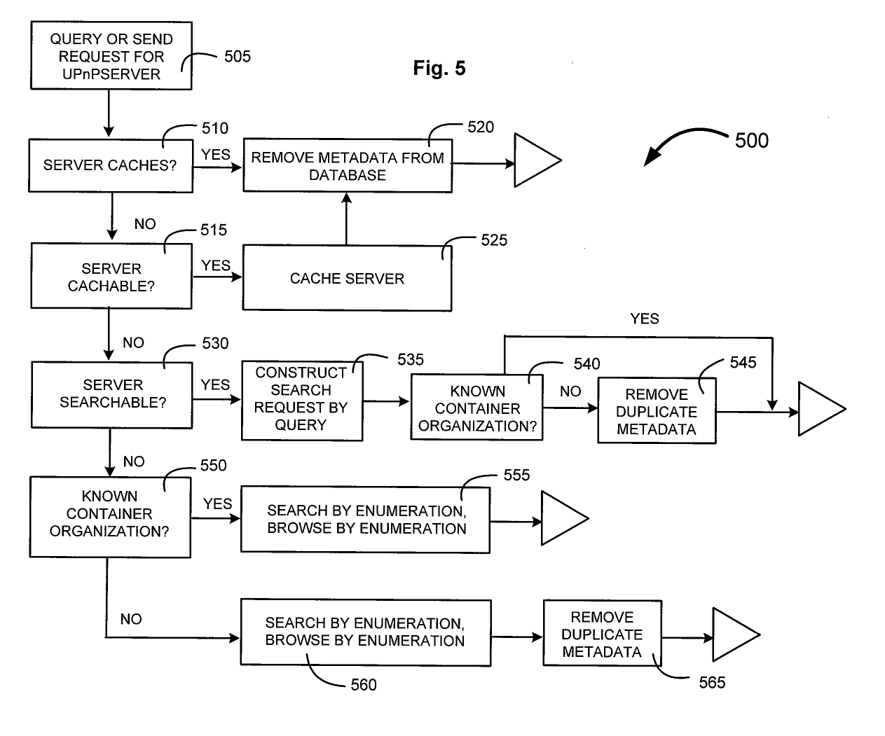

FIG. 5 is a flowchart illustrating a process to transform metadata of a container system according to one embodiment of the invention.

The process 500 starts at step 505 to request query or search for the UPnP server. This query or search applies from an application layer down to a network layer. Once it is passed to the network layer, the network layer knows if the particular server, which is being queried is searchable or non-searchable. If it is a searchable server, it goes and asks the server directly over the network connection. However, if it is a non-searchable server, it uses its internal database and cached metadata to respond to the query. At step 510, the process 500 determines whether the UPnP server is cached. If the server is cached, then the process 500 returns to metadata from the database (DB) at step 520. Otherwise, the process 500 continues at step 515 to determine whether the UPnP server is cacheable. If the UPnP server is cacheable, the process 500 continues to cache server and then returns to metadata from DB at steps 525 and 520 respectively. If no, the process 500 continues to determine whether the server is searchable at step 530. If it is determined that the UPnP server is searchable, the process 500 continues to construct search request per pdb query at step 535 and then at step 540, the process 500 determines whether the container organization is a known container organization (step 540). If yes, the process is terminated. If no, the process 500 removes duplicate metadata at step 545 and the process is then terminated. If it is determined that the server is not searchable at step 530, the process 500 continues at step 550 to determine whether the container organization is a known container organization. If yes, the process 500 searches by enumeration browse using container hierarchy at step 555 before the process is terminated. Otherwise, the process searches by enumeration browse by enumeration at step 560 and then continues at step 565 by removing duplicate metadata before the process is terminated. Step 550 may be used to find out if the server at least supports what is considered “normal” or “known containers”. If it is not a known container (i.e., director or producer), then metadata may not be extracted for the objects/files, and therefore, it is not able to report any useful information about the file to present to the user in the user interface (UI).

It is noted that cache server or server cacheable is referred to those non-searchable servers where the BDP has to cache its metadata internally in the database. Also, if searching is not supported, the system provides all the content and organizes content since the server cannot organize itself. This is called the “harvesting” step and caching into the internal database. Of course, if searching is supported, the server has organized its content and the system can do searches directly without having to waste time and resources organizing it.

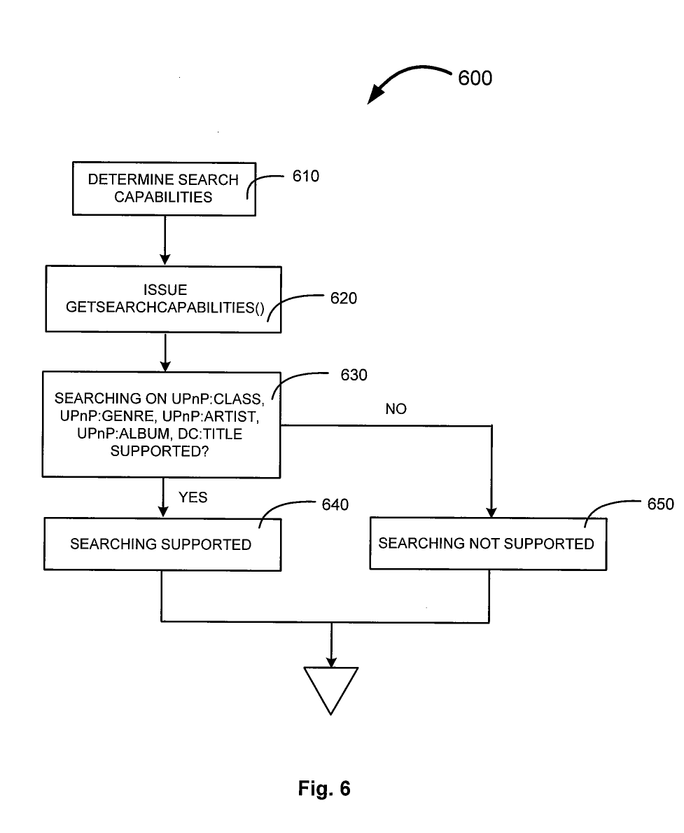

FIG. 6 is a flowchart illustrating a process to determine whether searching capability is supported in the container system according to one embodiment of the invention.

This is a process that determines the search capacities as described in FIG. 4, step 410. The process 600 starts out by determining whether the UPnP server has the search capacities (step 610). The process 600 then proceeds to issue get search capacities at step 620. The process 600 continues at step 630 to search for different categories (i.e., class, genre, artist, album, etc.) on the UPnP and dc: title to determine whether they are supported. At this point, it is determined whether the searching capability is supported (step 640) or not supported (step 650). The process 600 is then terminated.

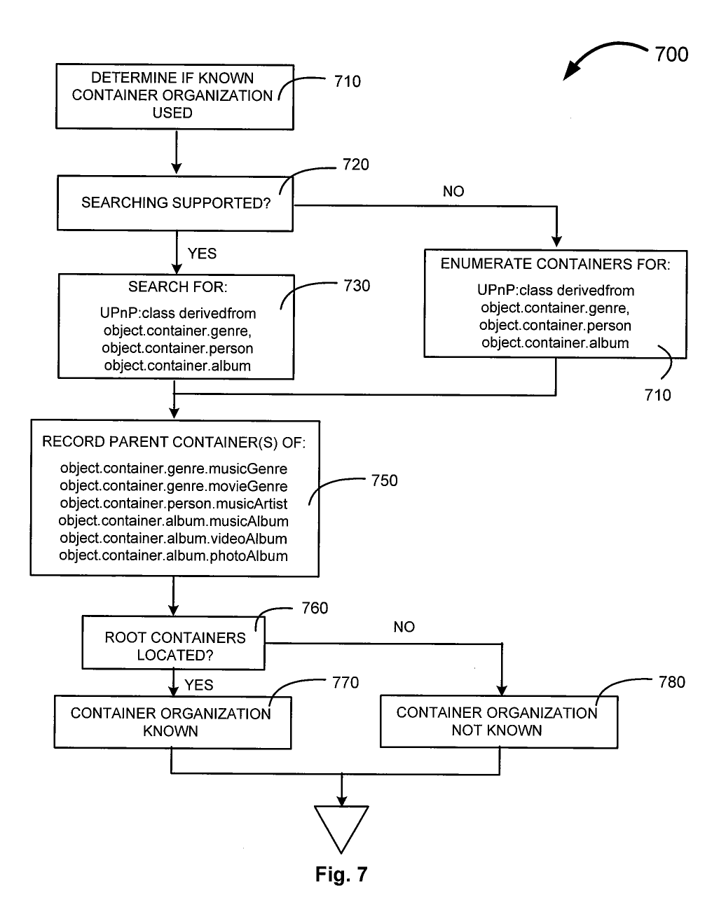

FIG. 7 is a flowchart illustrating a process to determine whether searching capability supports a known container organization according to one embodiment of the invention.

This process 700 continues when it is determined that a known container organization is used at step 710 (or as described earlier, step 550 of process 500). The process 700 proceeds to determine whether the searching is supported at step 720. If the search/categorize capabilities are supported, the process 700 searches for UPnP: class derives from, object containers (e.g., genre, person/artist, album, etc.) at step 730. Otherwise, process 700 enumerates containers for: UPnP: class derives for, object containers (e.g., genre, person/artist, album, etc.) at step 740. In other words, if the search is supported, the process 700 proceeds with a search; otherwise, the process 700 proceeds with an enumeration. The process 700 continues to record the containers (step 750). The object containers include genre (e.g., music, movie), person (e.g., artist, etc.), and album (e.g., music, video, photo, etc.). Process 700 continues at step 760 to determine the location of the root containers or whether the container organization is known. It is found that the container organization is a known container, the process goes to step 770. Otherwise, the process goes to step 780. The process 700 is terminated.

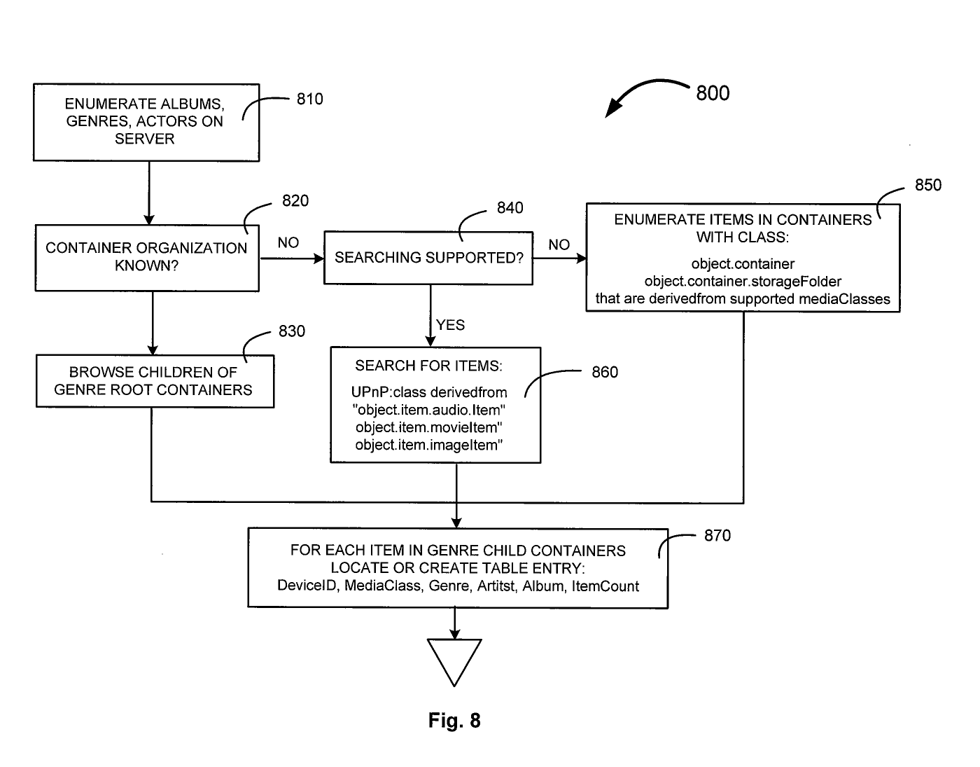

FIG. 8 is a diagram illustrating a process of enumerating different categories on a server in which one embodiment of the invention can be practiced.

The process 800 is a sub-process at step 810 (as described as step 430 of process 400). At step 810, the process 800 enumerates albums, genres, artists, on the server (i.e., client server 210). The process 800 continues at step 820 to determine whether the container organization is a known container. If yes, at step 830, the process 800 proceeds to browse children (i.e., subsets) of genre root containers. If no, the process 800 continues to determine whether search capabilities or categorize capacities are supported at step 840. If the search is supported, the process proceeds at step 860 to search for items (i.e., UPnP class derive from, object item audio, object item movie, object item image, etc. If the searching is not supported, at step 850, the process 800 proceeds to enumerate items in containers with different classes (e.g., object container, object container storage folder, etc. These items are derived from supported media classes. The process 800 then continues to locate or create table entry for each item in genre child containers (step 870). These may be device ID, media class, genre, artist, album, item count, etc. The process is then terminated.

It is noted that the children of genre root containers are actual metadata instances themselves and under them would be the individual media contents, i.e.:

Classical/

Mozart—5^{th} Symphony.mp3

Bach—12^{th} Concerto.wma

Where “Classical” is one of the children of the root “Genre” container, and “Mozart—5^{th} Symphony.mp3” is a child of the “Classical” container.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
detecting a first server;
determining the first server search capability;
harvesting metadata from the first server;
caching metadata into a database; and
reporting an application layer by a second server to a user interface.

2. The method of claim 1, wherein the application layer is embedded in a user interface.

3. The method of claim 2, wherein the user interface is a graphical user interface.

4. The method of claim 1, wherein the application is one of a music, video, and photo applications.

5. The method according to claim 1 further comprising determining if a known container is used.

6. The method according to claim 5 further comprising responding to a query using the database of cached metadata.

7. The method according to claim 1 wherein search capability includes organizing metadata in a media container.

8. The method of claim 5 further comprising enumerating albums, genres, actors on server of one of music, video, and photo applications.

9. An apparatus comprising:
a first server containing metadata; and
a user device connected to the first server for determining whether the first server has a search capability, the user device including a second server for harvesting metadata from the first server and caching the metadata into a database, the second server reporting an application layer to a user interface in communication with the user device.

10. The apparatus according to claim 9 wherein the application is one of a music, video, and photo applications.

11. The apparatus according to claim 9 wherein the user device determines whether the application contains a known container organization.

12. The apparatus according to claim 10 wherein the user device responds to a query using the cached metadata.

13. A computer-readable recording medium that stores therein a computer program that causes a computer to execute:
detecting a first server;
determining the first server search capability;
harvesting metadata from the first server;
caching metadata into a database; and
reporting an application layer by a second server to a user interface.

14. The computer-readable recording medium according to claim 13 further comprising determining if a known container is used.

15. The computer-readable recording medium according to claim 14 responding to a query using the database of cached metadata.

16. The computer-readable recording medium according to claim 13 wherein search capability includes organizing metadata in a media container.

17. The computer-readable recording medium according to claim 14 comprising enumerating albums, genres, actors on server of one of music, video, and photo applications.

18. A computer program that causes a computer to execute:
detecting a first server;
determining the first server search capability;
harvesting metadata from the first server;
caching metadata into a database; and
reporting an application layer by a second server to a user interface.

19. The computer program according to claim 18 further comprising determining if a known container is used.

20. The computer program according to claim 19 responding to a query using the database of cached metadata.

21. The computer program according to claim 18 wherein search capability includes organizing metadata in a media container.

22. The computer program according to claim 19 comprising enumerating albums, genres, actors on server of one of music, video, and photo applications.

23. A system comprising:
a user interface;
a first server containing metadata; and
a user device connected to the first server for determining whether the first server has a search capability, the user device including a second server for harvesting metadata from the first server and caching the metadata into a database, the second server reporting an application layer to the user device.

24. The system according to claim 23 wherein the application is one of a music, video, and photo applications.

25. The system according to claim 23 wherein the user device determines whether the application contains a known container organization.

26. The system according to claim 24 wherein the user device responds to a query using the cached metadata.
